(19) United States
(12) Patent Application Publication
(10) Pub. No.: US 2008/0302000 A1
(43) Pub. Date: Dec. 11, 2008

(54) Leak-Resistant Bait Station

(75) Inventor: Daniel Kidder, Greensboro, NC (US)

Correspondence Address: SYNGENTA CROP PROTECTION , INC.;PATENT AND TRADEMARK DEPARTMENT, 410 SWING ROAD, GREENSBORO, NC, 27409, US

(73) Assignee: Syngenta Crop Protection, Inc., Greensboro, NC (US)

(21) Appl. No.: 11/722,805

(22) PCT Filed: Dec. 19, 2005
(86) PCT No.: PCT/US2005/046035

§ 371 Date: Mar. 27, 2008

Related U.S. Application Data
(60) Provisional application No. 60/640,554, filed on Dec. 30, 2004.

(51) Int. Cl. A01M 1/20

(52) U.S. Cl. 43/131

(57) ABSTRACT

The invention includes a bait station having an internal air entrapment compartment. Air entrapped within the air entrapment compartment prevents water from wetting bait within the bait station when the station is submersed in water. In one embodiment, the bait station includes an enclosure having an airtight upper portion and at least one access opening having an uppermost first elevation. Toxic and/or non-toxic bait is contained within the enclosure. A first wall is positioned between the bait and the access opening and includes an upper rim at a second elevation. The second elevation is above the first elevation of the access opening. The bait may be liquid bait, solid bait, or palletized or granular bait. For liquid bait, the bait may be suspended in an adsorbent bait retainer such as an adsorbent foam block to retain the bait and prevent free liquid bait from leaking from the bait station.

### BACKGROUND

The invention relates to pest control devices and methods. More particularly, the invention relates to a leak-resistant bait station particularly suited for use with liquid baits for controlling pests such as ants or other insects.

Professional exterminators use bait stations for the control and extermination of small pests including insects. Bait stations typically include an enclosure containing bait. The bait may contain a toxicant, or a separate toxicant can be provided in the same enclosure. Suitable baits may be granular, gel, paste, or liquid in form. Such baits often are retained within a tray, holder, or receptacle within the enclosure. A bait station enclosure typically includes one or more access openings that permit small insects to enter and exit the enclosure. Once inside the enclosure, pests consume portions of the bait from the tray or receptacle. In the case of ant bait stations, foraging worker ants consume portions of the bait, exit the bait station, return to their colony, and regurgitate the consumed bait for further consumption by other ants in the colony. Ideally, the colony's queen, thereby exterminating the queen and eradicating the colony, consumes a portion of the regurgitated bait. Such bait stations may be refillable, or may be disposable, single-use stations containing single initial charges of bait.

In use, bait stations are positioned around the peripheries of building structures or are distributed in areas of known pest activity to eradicate or at least control unwanted pests. Commonly, bait stations are placed on a substantially level surface at or near ground level. If desired, the bait station may be staked to the ground, or otherwise secured in place. Some types of bait stations may be suspended at elevated heights, or mounted on vertical surfaces such as on exterior walls of buildings. The baits in bait stations attract insects to the bait stations from surrounding areas.

Liquid baits are an effective, convenient, and economical form of insect bait that may be used in bait stations such as insect bait stations. Liquid baits typically include at least one toxin suspended in a sweet formula. The sweet suspension attracts the pests, and entices the pests to ingest the toxin. Liquid baits typically are at least partially contained within a partially open bait tray within the bait station enclosure, or alternatively, may be directly contained within a receptacle or compartment within the enclosure. Alternatively, non-toxic liquid baits may be used to attract pests to a location where the pests are entrapped, exposed to a separate toxicant, or otherwise are exterminated or eradicated.

Because insect bait stations primarily are used outdoors and often are placed at or near ground level, the bait stations may be exposed to rain and accumulated rainwater. Some bait stations also may be subjected to submersing floodwater in flooded areas. Where such water reaches an access opening in a typical bait station enclosure, water may enter the bait station through the access opening. The intruding water also may reach the bait within the enclosure, and, particularly in the case of water-soluble liquid baits, the bait's toxin may become at least partially mixed with the intruding water. Accordingly, a portion of the bait's toxin may be carried from the enclosure as the intruding water recedes from the bait station. In certain situations, the introduction of a bait's toxin to a surrounding environment may be undesirable, and in some cases, may adversely impact one or more environmental regulations or restrictions. Another problem with bait stations that contain liquid bait is that a portion of the liquid bait may leak or spill from the enclosure as the bait station is handled, placed, or is otherwise physically disturbed. Such leaks or spills also may undesirably introduce toxins to the surrounding environment.

In order to prevent the unwanted dispersal or leakage of toxins from bait stations to surrounding environments, there is a need for an insect bait station that substantially prevents intruding water from reaching and wetting the bait within the bait station. In particular, there is a need for a bait station that substantially prevents pesticides in baits from leaching from the bait station when the bait station is submersed in water such as puddled rainwater or floodwater. Furthermore, there is a need for an insect bait station that substantially prevents liquid bait from spilling or leaking from the bait station enclosure.

### SUMMARY

The invention includes a bait station having an internal air entrapment compartment. Air entrapped within the air entrapment compartment prevents water from wetting bait within the bait station when the station is submersed in water. In one embodiment, the bait station includes an enclosure having an airtight upper portion and at least one access opening having an uppermost first elevation. A toxic and/or non-toxic bait is contained within the enclosure. A first wall is positioned between the bait and the access opening and includes an upper rim at a second elevation. The second elevation is above the first elevation of the access opening. The bait may be liquid bait, solid bait, or palletized or granular bait. For liquid bait, the bait may be suspended in an adsorbent bait retainer such as an adsorbent foam block to prevent free liquid bait from leaking or spilling from the bait station.

### BRIEF DESCRIPTION OF THE DRAWINGS

FIG. 1 is a perspective view of one embodiment of a bait station according to the invention;

FIG. 2 is a perspective view of a mating cap and base that form the enclosure of the bait station of FIG. 1;

FIG. 3 is a perspective view of the cap portion of FIG. 2 showing some internal features of the cap;

FIG. 4 is a perspective view of a base portion of the embodiment shown in FIG. 1;

FIG. 5 is an exploded top and rear perspective view of the embodiment of a bait station shown in FIG. 1;

FIG. 6 is an exploded bottom and rear perspective view of the embodiment of a bait station shown in FIGS. 1 and 5;

FIG. 7 is perspective view of the bait station of FIG. 1 with the cap portion removed;

FIG. 8 is a cross-sectional view of the embodiment of a bait station of FIG. 1 taken along line 8-8 as indicated in FIG. 1;

FIG. 9 is a cross-sectional view of a horizontally mounted embodiment of a bait station according the invention;

FIG. 10 is a cross-sectional view of a vertically mounted embodiment of a bait station according the invention;

FIG. 11 is a cross-sectional view of an embodiment of a bait station according the invention positioned in an inverted, upside down orientation; and

FIG. 12 is a cross-sectional view of another embodiment of the invention.

### DETAILED DESCRIPTION

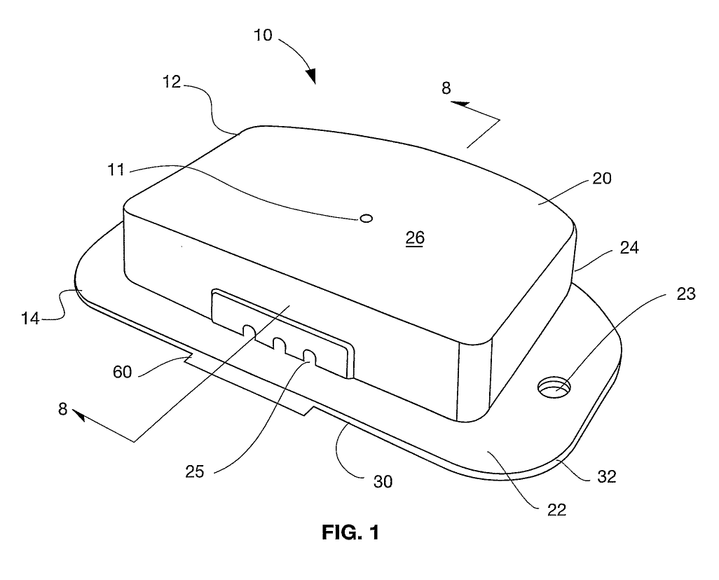

FIG. 1 shows one embodiment of a bait station 10 according to the invention. As shown in FIG. 1, bait station 10 includes a substantially hollow enclosure 12 surrounded by a substantially planar flange 14. In the embodiment shown, the enclosure is formed by a cap 20 and a base 30. The cap 20 includes a top 26, an outer wall 24, and an upper flange 22. At least one access opening 25 in the enclosure 12 permits small pests such as ants to enter and exit the enclosure 12. A removable seal tab 60 may be used to cover the access opening or openings 25 during shipment, handling, and storage. The seal tab 60 substantially prevents evaporation or degradation of bait within the enclosure 12 by preventing exposure of the bait to the ambient atmosphere. In the embodiment 10 shown in FIG. 1, three adjacent access openings 25 are located in a lower portion of the outer wall 24 proximate to the upper flange 22. When the enclosure 12 includes two or more access openings 25, the openings 25 preferably are located in close proximity to each other in the same side of the outer wall 24. The base 30 includes a lower flange 32 that is secured by either adhesion or fusion to the upper flange 22, thereby forming flange 14 and hermetically sealing the enclosure 12 except for access opening(s) 25. The overall size and internal volume of the enclosure 12 may vary depending on the desired capacity of the bait station 10 and the size of targeted pests.

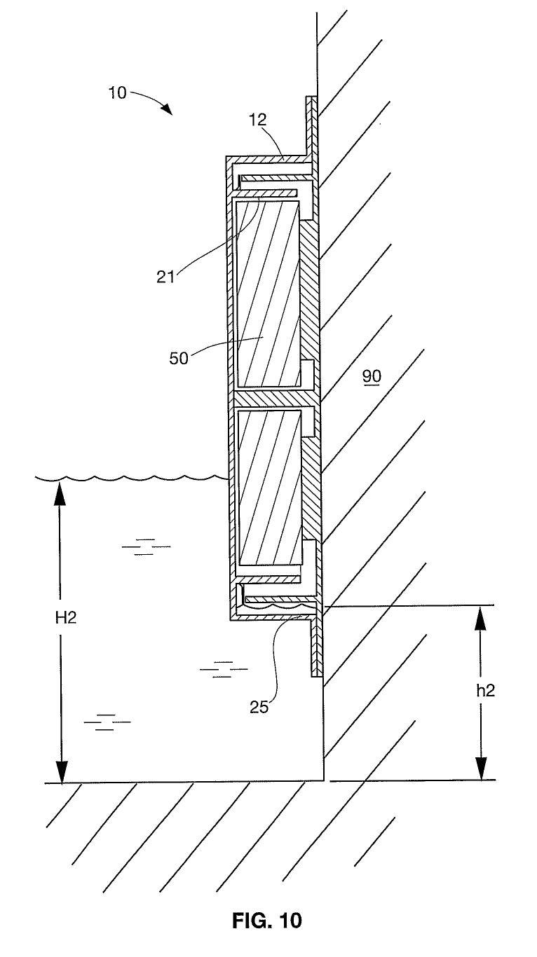

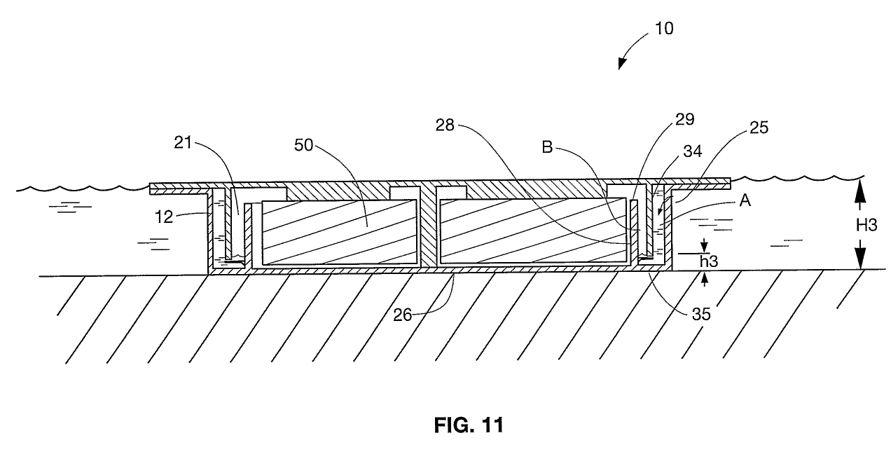

One or more mounting holes 23 may be provided in the flange 14 for securing the bait station 10 to a stationary foundation in a desired location. When the bait station is to be secured to the ground or earth, a stake (not shown) or similar device can be inserted through the mounting hole 23 and driven into the underlying ground to removably secure the bait station 10 in place. Alternatively, nails, screws, wire, or other types of removable fastening devices (not shown) may be used in combination with the mounting holes 23 to secure the bait station 10 to a surface or object. In a preferred arrangement, bait station 10 is mounted in a substantially horizontal position like that shown in FIG. 1. Alternatively, the bait station 10 may be substantially vertically mounted (as shown in FIG. 10, for example), such as on a building wall or the like. In such a vertically mounted orientation, the bait station 10 preferably is positioned with the access openings 25 facing downward. This preferred downward orientation of the access openings 25 maintains the leak-proof aspects of the bait station 10 as more fully described below. Even if positioned upside down (as shown in FIG. 11, for example), the bait station 10 remains leak-resistant.

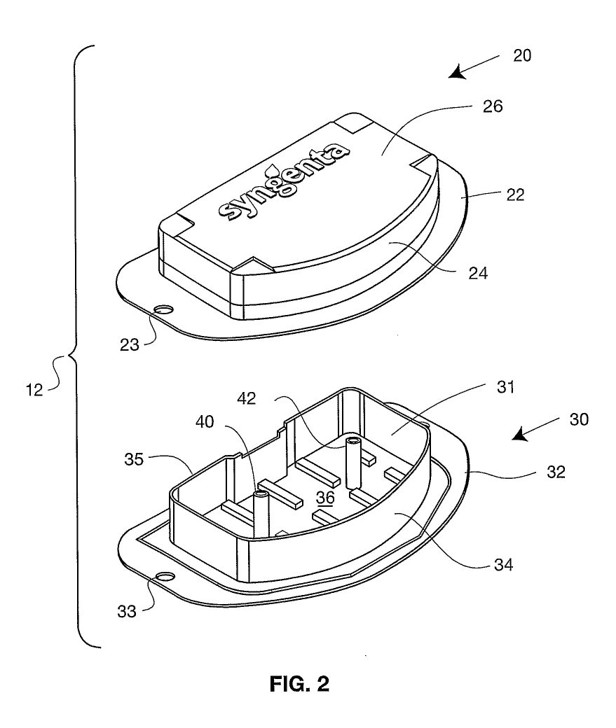

One preferred construction of the bait station 10 is shown in FIGS. 2-8. A construction for the bait station enclosure 12 is generally shown in FIG. 2. A base 30 includes an outwardly extending flange 32 and an upstanding wall 34 having an upper rim 35. The upstanding wall 34 and a floor 36 combine to form a bait receptacle 31. The base 30 may include one or more upstanding bosses 40, 42. The bosses 40, 42 provide strength to the enclosure by underpinning and supporting the top 26 of the overlying cap 20, and also act as locators or anchors for bait within the receptacle 31. A cap 20 is configured to substantially cover the base 30. Preferably, the upper flange 22 of the cap 20 and the lower flange 33 of the base 30 have matching profiles as shown. Mounting holes 23 and 33 are located in the mating flanges 22, 32 such that the holes 23, 33 substantially align with each other when the cap 20 is engaged on the base 30. The outer wall 24 of the cap 20 is slightly larger in girth than the upstanding wall 34 of the base 30, and surrounds and is outwardly spaced from the upstanding wall 34 when the cap 20 is engaged on the base 30.

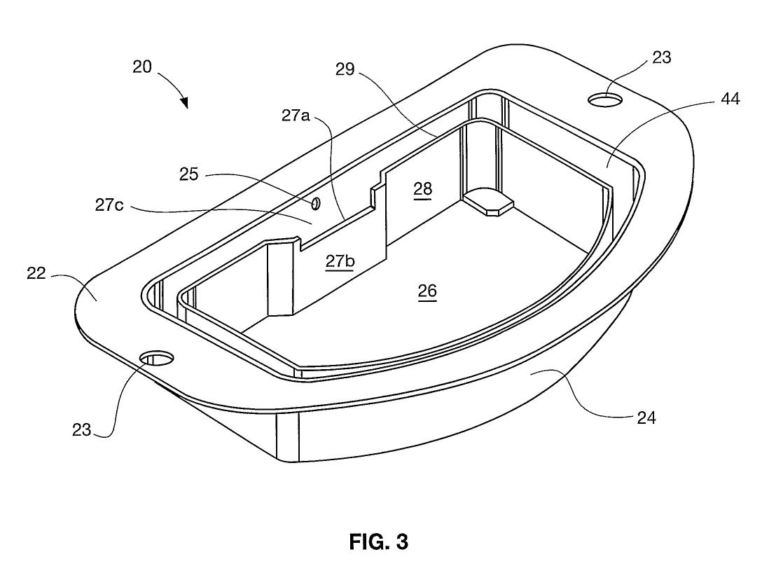

Details of one construction of the cap 20 are shown in FIG. 3. In this construction, the cap 20 generally has a top-hat shape formed by an upper flange 22, an outer wall 24, and a top 26. As shown in FIG. 3, an inner wall 28 downwardly depends from the top 26 and includes a lower rim 29. The inner wall 28 is inwardly spaced from the outer wall 24, thereby forming an annular gap 44 between the inner wall 28 and outer wall 24. The outer wall 24 includes one or more access openings 25. In the embodiment shown, the access opening 25 is centrally positioned on one side of the outer wall 24 proximate to the upper flange 22. The size of the access opening(s) 25 is selected based on the size of pests for which the bait station 10 is targeted. When the bait station 10 is intended to control ants, for example, the access opening(s) 25 may be quite small, such as less than or equal to about 4 mm in diameter.

As also shown in FIG. 3, a recessed portion 27b of the inner wall 28 may be recessed or inset from the outer wall 24 in a region that is proximate to the access opening(s) 25. This recessed portion 27b forms an access region 27c just inside the access opening(s) 25. The recessed portion 27b of the inner wall 28 may include a notch or aperture 27a in the lower rim 29 to at least partially form a primary bait access passageway 72 within the enclosure 12 as further described below.

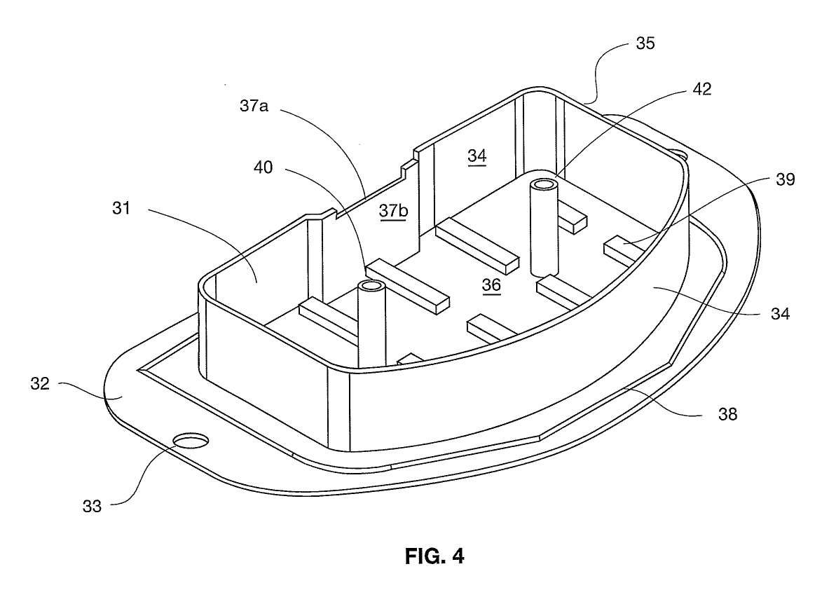

Details of a preferred construction of the base 30 are shown in FIG. 4. The base 30 includes an outwardly extending lower flange 32, a floor 36, and an upstanding wall 34 having an upper rim 35. The floor 36 and upstanding wall 34 combine to form a bait receptacle 31. One or more bait pedestals 39 may be provided on the floor 36 to elevate bait contained within the bait receptacle 31 above the floor 36. The upstanding and spaced bosses 40, 42 provide rigidity to the bait station 10, and also may locate and anchor bait within the bait receptacle 31. Similar to the inner wall 24 of the cap 20 as described above, a recessed portion 37b of the upstanding wall 34 may be inwardly recessed or inset in a region that is proximate to the access opening(s) 25 in the cap 20. This recessed portion 37b combines with the recessed portion 27b of the cap 20 to form an enlarged access region 27c just inside the access opening(s) 25 in the cap 20. The recessed portion 37b of the upstanding wall 34 may include a notch or aperture 37a in the upper rim 35 to at least partially form a primary bait access passageway 72 within the enclosure 12 as further described below.

A raised lip or energy deflector 38 may be provided on the upper surface of the lower flange 32 like that shown in FIG. 4. In a preferred arrangement, the lower flange 32 of the base 30 is ultrasonically fused or welded to the upper flange 22 of the cap 20 at a fusion joint 80 formed between the abutted flanges 22, 32. When ultrasonic welding is used to fuse and seal the lower flange 32 of the base 30 to the upper flange 22 of the cap 20, the energy deflector 38 acts as a flux, thereby facilitating melting and fusion of the flanges 22, 32 within the joint 80.

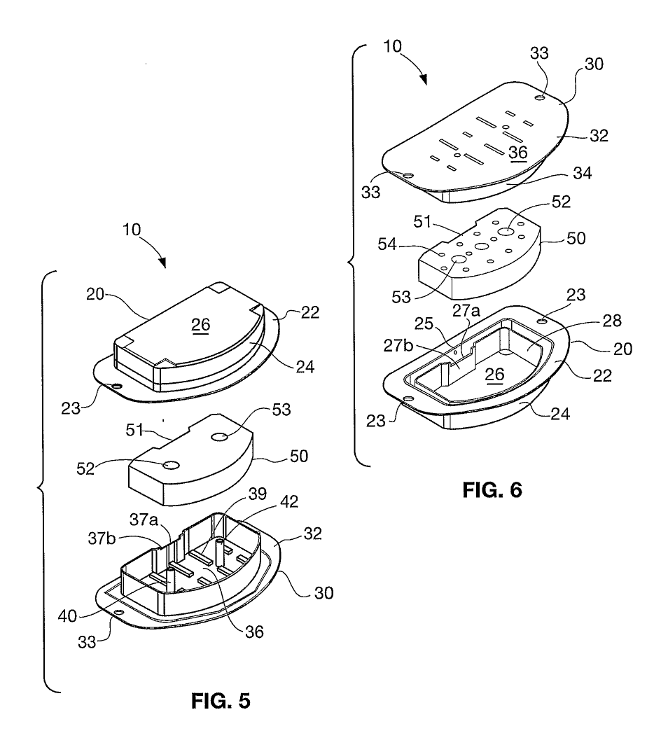

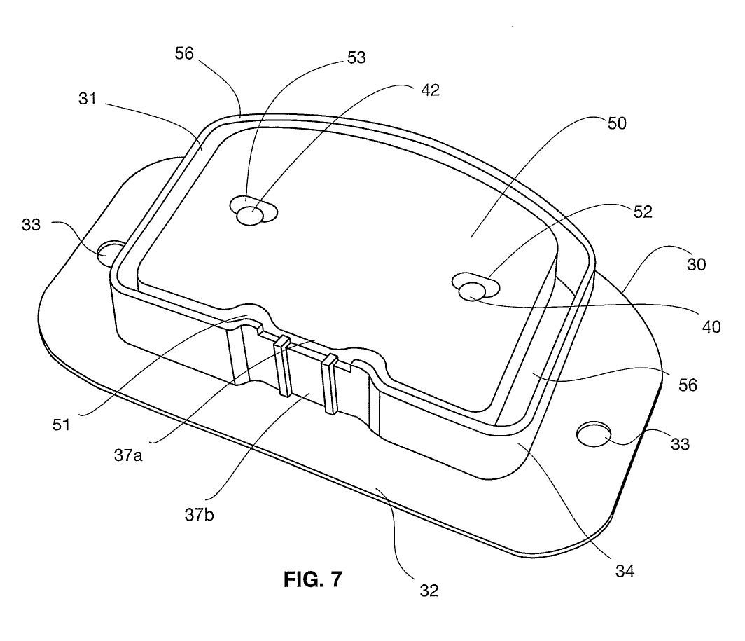

FIGS. 5 and 6 show exploded views of an embodiment of an assembled bait station 10 that includes the cap 20 and base 30 as described above. In this embodiment 10, a bait retainer 50 is located within the bait receptacle 31 in the base 30. Preferably, the bait retainer 50 is constructed of an open-cell matrix material capable of absorbing and/or suspending a substantial quantity of suitable liquid bait. One highly effective liquid bait for insects such as ants contains Syngenta Crop Protection, Incorporated's proprietary toxin thiamethoxam. The bait retainer 50 may be constructed of a suitable adsorbent foam material, for example. In a preferred embodiment, the bait retainer 50 is constructed of floral foam material. Floral foam is a finely textured, highly adsorbent, open-celled polystyrene foam material commonly used in the floral and crafts industries. Dow Chemical Company produces suitable floral foams for use in the invention under the brand name Styrofoam(g. At least for use with liquid baits, the bait retainer 50 may be shaped to substantially replicate the shape of the bait receptacle 31 in the base 30. Holes 52, 53 in the retainer 50 receive the upstanding bosses 40, 42 to centrally locate and anchor the retainer 50 in the receptacle 31 as shown in FIG. 7. Preferably, the bait retainer 50 is slightly smaller in width and depth than the receptacle 31 such that a peripheral annular gap 56 is provided between the bait retainer 50 and the inner surface of the upstanding wall 34.

Other types of baits such as solid, granular, or pelletized baits also may be used in a bait station according to the invention. When solid bait is used, the solid bait may be configured like the foam liquid-bait retainer 50 described above. Where granular or pelletized baits are used, the baits may be retained within a suitable bait retainer 50 such as a mesh bag (not shown) to prevent small granules or pellets from spilling from the bait receptacle 31 and bait station 10, and from becoming lodged in the various gaps and openings within the enclosure 12. A suitable bait retainer 50 for granular or pelletized baits should include openings that are sufficiently small to prevent bait granules or pellets from exiting the bag, while also being sufficiently large to permit targeted pests to access the bait within the retainer 50.

As described above and as shown in FIGS. 4 and 5, the floor 36 of the base 30 preferably includes one or more bait pedestals 39 that maintain a vertical gap between the floor 36 and the bottom of the bait retainer 50. Hence, insects can traverse through this gap to access the bait retainer 50. As shown in FIG. 6, the bottom of the retainer 50 may include a plurality of small blind holes 54. These holes 54 aid in retaining the shape of the foam bait retainer 50 during manufacture, and also provide feeding locations for very small pests who access the bait retainer 50 from its bottom.

Once the bait retainer 50 is positioned within the bait receptacle 31, the retainer 50 is filled with a suitable liquid bait, such as a liquid bait formula containing thiamethoxam. Preferably, the quantity of liquid bait is limited to an amount that is capable of being fully absorbed by the bait retainer 50 to prevent free liquid bait from accumulating in the bottom of the bait station 10.

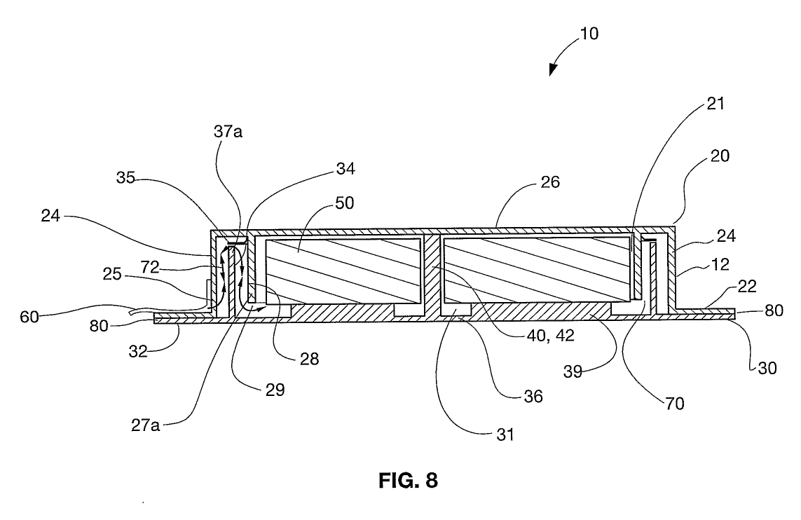

FIG. 8 shows inner details of one embodiment of the bait station 10 in cross-section, taken along line 8-8 as shown in FIG. 1. In this embodiment 10, the upper flange 22 of the cap 20 rests atop the lower flange 32 of the base 30. The upper flange 22 and lower flange 32 are fused or adhered together by any suitable method that is sufficient to form an airtight seal between the flanges 22, 32. Preferably, the adhesion or fusion between the flanges 22, 32 is sufficiently strong to make the enclosure extremely difficult to breach, thereby making the bait station tamper-resistant and child-resistant. For example, the flanges 22, 32 may be ultrasonically welded or adhered together by a suitable sealant, glue or adhesive tape.

The bait retainer 50 substantially is enclosed within the bait receptacle 31 by the inner wall 28, the floor 36, and the top 26. Preferably, the bait retainer 50 is elevated above the floor 36 by the bait pedestals 39, and is centered in the bait receptacle 31 by the bosses 40, 42. In this position, gaps preferably are provided around the bait retainer 50 on all sides and below (see FIGS. 7 and 8). These gaps provide access to the surfaces of the bait retainer 50 and the liquid bait suspended therein. Though a vertical gap also may be provided between the top surface of the bait retainer 50 and the top 26 of the enclosure 12 (not shown), having substantially zero gap between the top surface of the bait retainer 50 and the underside of the top 26 prevents rattling or shifting of the retainer 50 within the enclosure 12. Furthermore, providing access to the top surface of a liquid bait retainer 50 is less important than providing access on the sides and bottom because gravity causes liquid bait suspended in the retainer 50 to concentrate in lower portions of the bait retainer 50.

When the bait station 10 is placed in a desired location, the removable seal 60 covering the access opening(s) 25 is removed, thereby exposing the access opening(s) 25 and providing access to the bait station 10 for targeted pests such as ants or other insects. As shown in FIG. 8, a primary passageway 72 leads from the access opening(s) 25 to the bait retainer 50. In use, a pest enters the bait station 10 through an access opening 25, crawls over the upstanding wall 34, crawls under the inner wall 28, crawls to the bait retainer 50, and consumes a portion of the bait or the bait-saturated retainer 50. After consuming a portion of the bait, a pest exits the bait station by crawling under the inner wall 28, crawling over the upstanding wall 34, and passing through an access opening 25.

Because the interior of the bait station may become crowded with entering and exiting pests or blocked by accumulated debris at or near the access opening(s) 25, the recessed portions 27b, 37b of the walls 24, 34 combine to provide an enlarged access region 27c in this portion of the bait station 10. In addition, the notch or aperture 37a in the upper rim 35 of the upstanding wall 34 and the notch or aperture 27a in the lower rim 29 of the inner wall 28 provide enlarged gaps or openings between the walls 34, 28 and the top 26 and floor 36 in the access region 27c. Though access is enhanced in the region 27c proximate the access openings, pests also can access the bait retainer 50 from other directions by crawling through the various gaps surrounding the bait retainer 50.

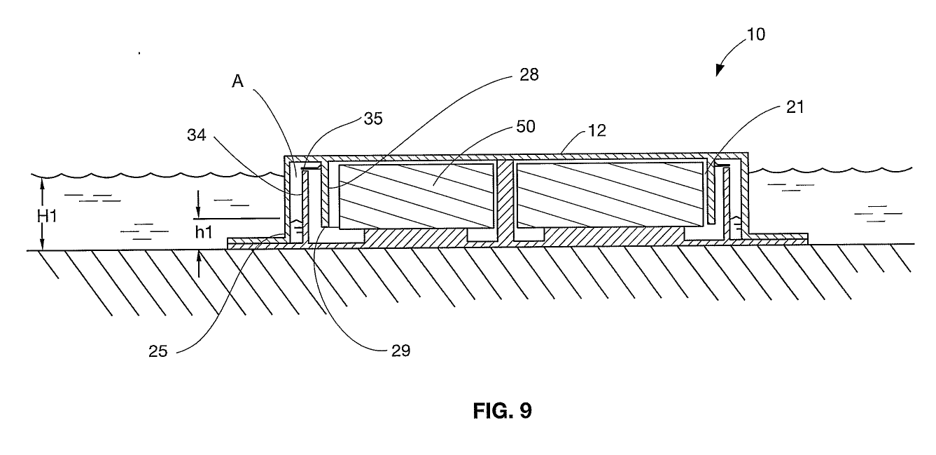

For liquid baits, the bait retainer 50 absorbs and retains the liquid bait within the enclosure 12, thereby preventing free liquid bait from being spilled, leaked, or splashed from the enclosure 12 in dry ambient conditions. As shown in FIG. 8, the spaced upstanding wall 34 of the base 30 and downwardly depending inner wall 28 of the cap 20 combine to form a bait containment baffle or water intrusion baffle 70. In order to prevent bait toxins from leaching from the enclosure 12 when the bait station becomes at least partially submersed by water, the containment baffle 70 forms an air entrapment compartment 21 surrounding the bait retainer 50. In embodiment 10 of the bait station, the containment baffle 70 includes spaced walls 28 and 34. In the horizontal and upright bait station orientation shown in FIGS. 8 and 9, accumulated water that at least partially submerses the bait station 10 can partially enter the access opening(s) 25.

As shown in FIG. 9, as water surrounds the bait station 10 at an elevation “H₁,” entering water is able to rise to only a limited height “h₁” in the annular region “A” between the outer wall 24 and the upstanding wall 34. As the water rises, air occupying the interior of the bait station 10 becomes entrapped in the air entrapment compartment 21. The static pressure of the entrapped air acts to prevent the intruding water from rising above the topmost portion of the access opening(s) 25 having an elevation “h₁,” thereby preventing the water from reaching and wetting the bait retainer block 50 and liquid bait therein. Even if the accumulated water completely submerses the bait station 10, the entrapped air in the bait station 10 effectively prevents the enclosed liquid bait from leaching from the bait station 10 by the encroaching water.

The bait station 10 also effectively prevents rising water from reaching the bait retainer 50 and bait within the bait station 10 when the bait station is substantially vertically oriented and mounted on a wall or other object 90 as shown in FIG. 10. In this orientation, the access opening(s) 25 must be substantially downwardly positioned as shown. As water accumulates around the bait station 10 to a level “H₂” and water enters the access opening(s) 25, air again becomes entrapped within the bait station 10 and air entrapment compartment 21. The entrapped air prevents the intruding water from rising within the bait station 10 above an elevation “h₂.” As in the horizontally oriented bait station described above, the entrapped air is effective to prevent the water from wetting the bait retainer 50 and the liquid bait suspended therein, even if the bait station 10 is completely submersed in water.

The bait station 10 also is effective to prevent infiltration by submersing water when the bait station 10 is inverted in an upside down orientation like that shown in FIG. 11. As submersing water accumulates to an elevation “H₃,” some of the water enters the access opening(s) 25 and flows downward through annular space “A.” The inner wall 28 prevents the intruding water from reaching the bait retainer 50. In addition, air entrapped within the enclosure's air entrapment compartment 21 formed by wall 34 prevents the intruding water from rising above a height “h₃” in annular space “B” and from flowing over and past the inner wall 28 to the bait retainer 50. Therefore, even if the bait station 10 is positioned upside down and is completely submersed in water, the station 10 is effective to prevent intruding water from leaching toxins from the bait retainer 50 and the enclosure 12.

In an embodiment like that shown in FIG. 1, the flange 14 outwardly extends a substantial distance from the outer wall 24 and the access opening(s) 25 therein. The protruding flange 14 provides a physical barrier that aids in preventing children or other persons from placing their mouths on the outer wall 24 at the access opening(s) 25, thereby effectively preventing ingestion of a toxin from the bait station 10. Preferably, the flange 14 outwardly extends from the outer wall 24 in an area proximate to the access opening(s) 25 by at least about 0.5 inch.

The base 30 and cap 20 described above may be constructed of any suitable material or combination of materials. In a preferred embodiment, the cap 20 and base 30 are constructed of a durable and moldable plastic such as polyethylene with a nominal thickness of about 0.01 inch to about 0.15 inch. Preferably, the selected enclosure material is sufficiently strong and tough to make the enclosure tamper-resistant.

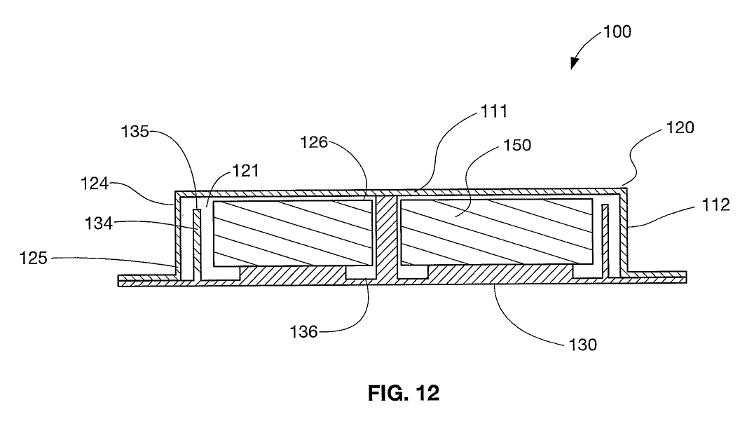

Another embodiment of a bait station 100 according to the invention is shown in FIG. 12. In this embodiment 100, an enclosure 112 includes a base 130 having a floor 136 and an upstanding wall 134 with an upper rim 135. The enclosure 112 farther includes a cap 120 having a top 126 and an outer wall 124 with at least one access opening 125 therein. Like the embodiment 10 described above, embodiment 100 also is effective to prevent submersing water from wetting bait within the bait retainer 150 when the station 100 is mounted substantially horizontally, or when the station 100 is mounted substantially vertically with the access opening(s) 125 substantially facing downward. In either a preferred substantially horizontal or a substantially vertical orientation, intruding water that enters the access opening(s) 125 is prevented from reaching the bait retainer by air entrapped within an air entrapment compartment 121 within the enclosure 112.

Although specific embodiments of the present invention have been illustrated and described in detail, it is to be expressly understood that the invention is not limited thereto. The above detailed description of the embodiment is provided for example only and should not be construed as constituting any limitation of the invention. Thus, modifications will be obvious to those skilled in the art, and all modifications that do not depart from the spirit of the invention are intended to be included within the scope of the appended claims.

For example, the embodiments of a bait station described above principally are intended for single use and subsequent disposal. Persons of ordinary skill in the art will recognize, however, that a refillable version of the above-described embodiment can be made by providing a reclosable or resealable fill hole 11, 111 in the cap 20, 120 for injecting additional liquid bait into an enclosed bait retainer (as shown by way of example in FIGS. 1 and 12). Similarly, the cap 20, 120 may be removably attached and sealed to the base 30, 130. In such modifications, the bait station may be refilled with bait when a previous charge of bait becomes depleted or has diminished potency. When the cap 20, 120 is made to be removable, the bait retainer 50, 150 also may be replaced as needed. Furthermore, while the specific illustrative embodiments described above primarily are directed to bait stations for very small pests such as ants and other small insects, larger bait stations incorporating water-proofing air-lock features like those described above also may be produced for controlling larger pests, such as rodents. These and other such modifications are intended to be within the scope of the appended claims. In addition, terms such as “top,” “bottom,” “floor,” “upper,” “lower,” “upstanding,” “downward”, and “uppermost,” for example, are used herein to describe relative directions and positions only, and are not intended to be strictly limiting.

1-12. (canceled)

13. A bait station comprising:
(a) an enclosure being substantially airtight except for at least one access opening therein, wherein the access opening has an uppermost first elevation;
(b) a bait compartment within the enclosure; and
(c) a first wall between the bait compartment and the access opening, the first wall having an upper edge at a second elevation;
(d) wherein the first elevation is below the second elevation.

14. A bait station according to claim 13 and further comprising a second wall having a lower rim at a third elevation, the second wall between positioned between the bait compartment and the first wall and the third elevation being lower than the second elevation.

15. A bait station according to claim 13 wherein the enclosure comprises an outer wall and a flange extending outwardly therefrom.

16. A bait station according to claim 15 wherein the flange extends outwardly from the outer wall by at least about 0.5 inch.

17. A bait station according to claim 15 wherein the flange includes at least one mounting means.

18. A bait station according to claim 13 and further comprising a bait retainer.

19. A bait station according to claim 18 further comprising a liquid bait suspended in the bait retainer.

20. A bait station according to claim 18 wherein the bait retainer comprises an adsorbent material.

21. A bait station according to claim 19 wherein the adsorbent material is an adsorbent foam.

22. A bait station according to claim 21 wherein the adsorbent foam is floral foam.

23. A bait station according to claim 13 and further comprising at least one bait pedestal.

24. A bait station according to claim 13 wherein the bait is granular, solid or pelletized bait.

25-28. (canceled)

29. A bait station comprising:
(a) a bait-receiving receptacle;
(b) access means for permitting insects to enter and exit the bait station; and
(c) air entrapment means for entrapping air to block water from entering the bait station and wetting the bait-receiving receptacle.

30. A bait station according to claim 29 comprising an outer enclosure and wherein the access means comprises at least one opening in the enclosure.

31. A bait station according to claim 29 wherein the air entrapment means comprises a baffle configured to entrap air within the bait station.

32. A bait station according to claim 31 wherein the baffle comprises at least one wall.

33-41. (canceled)

42. A pest bait station comprising;
(a) an outer wall having at least one access opening therein;
(b) a bait receptacle; and
(c) an air entrapment compartment substantially covering the bait receptacle;
(d) wherein the air entrapment compartment is configured to entrap air such that entrapped air within the entrapment compartment substantially prevents accumulated water that at least partially submerses at least a portion of the bait station from flowing through the access opening and into the bait receptacle while permitting at least some pests to access to the bait receptacle.

43. A pest bait station according to claim 42 and further comprising a bait retainer within the bait receptacle.

44. A bait station according to claim 43 wherein the bait retainer comprises an adsorbent material.

45. A bait station according to claim 44 and further comprising liquid bait suspended in the bait retainer.

46. A bait station according to claim 44 wherein the adsorbent material is an adsorbent foam.

47. A bait station according to claim 46 wherein the adsorbent foam is floral foam.

48-54. (canceled)

55. A method of preventing the leaching of a bait or pesticide from an access opening in a bait station, the method comprising entrapping air within an enclosure containing bait, whereby the entrapped air substantially prevents water from entering the bait station and carrying a portion of the bait or pesticide from the bait station through the access opening.

56. A bait station comprising:
(a) a base including a floor and an upstanding wall having an upper rim, the upstanding wall and floor forming a bait receptacle;
(b) a cap including a top and an outer wall having at least one access opening therein, the outer wall being outwardly spaced from the upstanding wall of the base;
(c) wherein the upper rim has an elevation that is above a highest portion of access opening, and wherein gaps between the upstanding wall and the outer wall and between the upper rim and the top combine to define a passageway between the access opening and the bait receptacle.

57. A bait station according to claim 56 and further comprising an upper flange outwardly extending from the outer wall of the cap, and a lower flange outwardly extending from the base.

58. A bait station according to claim 57 wherein the upper and lower flanges are substantially sealed together.

59. A bait station according to claim 58 wherein the upper and lower flanges are at least partially fused together.

60. A bait station according to claim 57 wherein at least a portion of at least one of the upper and lower flanges extends outwardly from the outer wall proximate to the access opening at least 0.5 inch.

61. A bait station according to claim 57 wherein the upper and lower flanges include at least mounting means.

62. A bait station according to claim 56 and further comprising a bait retainer in the bait receptacle.

63. A bait station according to claim 62 wherein the bait retainer comprises an adsorbent material.

64. A bait station according to claim 63 further comprising liquid bait suspended in the bait retainer.

65. A bait station according to claim 63 wherein the adsorbent material is an adsorbent foam.

66. A bait station according to claim 63 wherein the adsorbent foam is floral foam.

67. A bait station according to claim 62 further comprising at least one boss substantially extending between the floor and the top.

68. A bait station according to claim 67 wherein the boss upwardly extends from the floor.

69. A bait station according to claim 66 wherein the bait retainer is engaged on the boss.

70. A bait station according to claim 56 further comprising at least one notch in the upper rim, the notch at least partially defining a bait access path.

71. A bait station according to claim 56 and further comprising a quantity of bait in the bait receptacle, wherein the quantity of bait is liquid bait, solid bait, palletized bait, or bait granules.

72. A bait station according to claim 56 and further comprising at least one bait pedestal in the bait receptacle.

73. A bait station according to claim 56 wherein the bait station is substantially air tight except for the access opening.

74. A bait station according to claim 56 further comprising a removable seal covering the access opening.

75. A bait station according to claim 56 wherein a portion of the upstanding wall proximate to the access opening is inwardly recessed from the outer wall.

76. A bait station according to claim 56 and further comprising an inner wall downwardly depending from the top and having a lower rim, wherein gaps between the outer wall and the upstanding wall, the upper rim and the top, the upstanding wall and the inner wall, and the lower rim and the floor combine to define a passageway between the access opening and the bait receptacle.

77. A bait station according to claim 76 and further comprising at least one notch in the lower rim, the notch at least partially defining a bait access path.

78. A bait station according to claim 76 wherein a portion of the inner wall proximate to the access opening is inwardly recessed from the outer wall.

79. A bait station according to claim 42 wherein the bait station is in a substantially horizontal position.

80. A bait station according to claim 79 wherein the bait station is positioned upside down.
